(19) United States
(12) Patent Application Publication
(10) Pub. No.: US 2010/0044998 A1
(43) Pub. Date: Feb. 25, 2010

(54) WHEELED VEHICLE, HITCHING METHOD, UNHITCHING METHOD, METHOD FOR MANAGING SAID VEHICLES AND RESULTING TRAIN OF VEHICLES

(75) Inventor: Jean-Laurent Franchineau, Paris (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EUROLUM, 75001 Paris (FR)

(21) Appl. No.: 12/300,897

(22) PCT Filed: May 14, 2007
(86) PCT No.: PCT/FR07/51265

§ 371 Date: Aug. 28, 2009

(30) Foreign Application Priority Data
May 17, 2006 (FR) 0651788

(51) Int. Cl. B60D 1/54; B60D 1/00; G06Q 90/00

(52) U.S. Cl. 280/491.1; 280/504; 705/500

(57) ABSTRACT

The invention relates to an autonomous wheeled vehicle (100; 200) having a driver's cabin (16) and a space (18) for transporting passengers and/or objects, to a coupling procedure, to an uncoupling procedure, and to a method of managing said vehicles, and also to the resulting vehicle train. In characteristic manner, the vehicle includes: a steering front axle (12); a retractable coupling system (22) comprising a first portion (221) situated at the front of the vehicle (100; 200) and a second portion (222) situated at the rear of the vehicle (100; 200), the first portion (221) of one vehicle (100; 200) being suitable for co-operating with the second portion (222) of another vehicle (100; 200) when the coupling system (22) is extended, so as to connect the vehicles (100; 200) together by forming a coupling between them; and also protector means for protecting said coupling. The invention is applicable to buses.

The invention relates to an autonomous wheeled vehicle provided with a driver's cabin and a space for transporting passengers and/or objects, a procedure for coupling together at least two such vehicles, and a vehicle train, and also to a procedure for uncoupling said vehicle train, enabling it to be uncoupled completely or in part.

The invention also relates to a method of managing a network for transporting people and/or objects using such vehicles, to a method of managing a set of vehicles of the same type, and to a method of transporting passengers and/or objects by means of a set of vehicles of the same type.

Conventionally, in order to transport passengers or goods by road, vehicles of different sizes are used in order to satisfy varying needs in terms of volumes of passengers or objects. The term “object” is used to cover any thing that is transportable, whether solid, liquid, gaseous, in blocks, or powder form, for example goods or any other type of article, such as household or industrial waste.

In the field of public transport, several phenomena are observed. Built-up areas have expanded considerably. Places of residence, of work, of consumption, and of leisure have become spaced apart from one another, thus requiring more and more kilometers to be traveled by road in order to offer a transport service. Some kilometers at the periphery of such built-up areas present low levels of traffic.

Depending on the built-up area, public transport networks can present a variety of forms, and generally they are in the form of a network in the form of a tree structure or a star structure.

The total capacity of vehicles, which is generally dimensioned for the highest-traffic zones of the hypercenter, is no longer necessary at the periphery, leading to transporting empty space, and thus constituting a factor in terms of investment and operating costs, of energy consumption, and of excessive nuisance both for the operator and for the surroundings. In peripheral zones, a shorter vehicle suffices. In contrast, in town centers, a longer vehicle is useful.

Thus, if long vehicles are used, such as articulated buses, then they present a satisfactory load factor only in the town center and only during busy periods.

Solutions have been proposed by using two types of vehicle: short vehicles for low-traffic peripheral zones of the network having routes that join together at nodes of the network where long vehicles take over to travel over the heavier-traffic central zones, while the short vehicles go back in the opposite direction. Nevertheless, under such circumstances, although the number of vehicles can be better adapted to the needs of the network, for travelers there remains a major disadvantage since they must all change vehicle at the transition nodes between the central zone (ZC) and the peripheral zones.

It is also known to couple a leading, head car acting as a tractor that is connected via a coupling to one or more following transport trailers so as to form a vehicle train running on the road. Documents WO 2004/014715 and U.S. Pat. No. 4,948,157 presents vehicles of that kind in the form of buses with or without bellows between trailers. Document U.S. Pat. No. 6,926,344 describes that kind of bellows, as is used in particular in articulated buses.

Nevertheless, the type of articulated vehicle described presents a certain number of drawbacks. In particular, the vehicle is not modular, it is difficult to store, and it presents excessive fuel consumption during off-peak periods.

The vehicle that can be modulated presents asymmetry. The head vehicle is different from the other modules and it is not possible to permutate all of the different vehicles.

Similarly, document FR 2 606 354 provides for road vehicles that can be driven autonomously or that can be coupled together to form a road train with a single driver: nevertheless, the solution proposed is constricting in terms of the manual procedure for coupling and uncoupling the vehicles.

An object of the present invention is to provide a road vehicle for transporting people and/or objects that enables the drawbacks of the prior art to be overcome.

In particular, the present invention seeks to propose an autonomous road vehicle that can be assembled together with other, identical vehicles quickly and easily and in reversible manner so as to form a vehicle train, the vehicle train itself being capable of being taken apart in full or in part so as to form a fleet of autonomous vehicles of various lengths for matching the varying loads on the network in terms of passengers and/or objects, as a function of the requirements of each zone at any given time, and taking account of peak and off-peak periods.

Furthermore, in addition to ease of coupling and uncoupling, it is desired to propose a vehicle which, in the coupled position, forming a vehicle train, and in the uncoupled position, providing an autonomous vehicle, ensures safety for people situated outside the vehicle(s).

To this end, according to the present invention, the autonomous wheeled vehicle is provided with a driver's cabin and a space for transporting passengers and/or objects, and it is characterized in that it presents:
a steering front axle and, in particular but not essential manner, a steering rear axle;
a retractable coupling system comprising a first portion situated at the front of the vehicle and a second portion situated at the rear of the vehicle, the first portion of one vehicle being suitable for co-operating with the second portion of another vehicle, when the coupling system is extended, in order to connect the vehicles together by forming a coupling between them; and
protector means for protecting said coupling.

In this way, it will be understood that because these identical vehicles can travel alone in independent manner and can be assembled together to form an articulated vehicle train of greater capacity, identical road vehicle assemblies are obtained that can be modular along their routes, thus making it possible to organize a transport network so as to assemble or disassemble these autonomous road vehicle trains depending on requirements. When they are separated, these vehicles are autonomous, having both a driver and propulsion means.

The retractable nature of the coupling system ensures that it is discreet and provides safety, except when the coupling system is extended and forms a coupling with the coupling system of another vehicle.

This solution also provides safety for people when the coupling system is extended to form a coupling with the coupling system of another vehicle, because of the protector means for protecting said coupling, e.g. in the form of a bellows and/or a protective skirt.

Similarly, the physical coupling or decoupling procedure can be performed in semiautomatic mode (controlled by a single operator from the driver's cabin), or in fully automatic mode. Thus, the coupling or uncoupling procedure can be performed in particular when the vehicles and/or vehicle trains are running over special areas, in particular on a fenced-off site, in order to provide a maximum amount of security.

Overall, the solution of the present invention makes it possible to use the passenger or object transport vehicle in a manner the is more rational.

In advantageous and preferred manner, said second portion of the coupling system can be activated so as to pass from a retracted position towards an extended position in which said second portion is suitable for co-operating with said first portion of the coupling system of another vehicle so as to form a coupling between them.

In this way, when not in use for forming a coupling between two vehicles, because the second portion is retracted, e.g. into the inside of the vehicle, firstly the coupling system is made essentially invisible, and secondly it ceases to be dangerous.

Preferably, said second portion of the coupling system presents a hitching bar capable of passing automatically from its retracted position to its extended position, and vice versa.

In order to facilitate the coupling maneuver, provision is advantageously made for the coupling system to further present means for guiding the displacement of the second portion between the retracted position and the extended position. Also, provision is advantageously made for said coupling system to further present guide means serving, on the second portion passing into its extended position, to guide its coming into co-operation with said first portion of the coupling system.

According to another preferred disposition of the present invention, the coupling system includes connection means that allow for clearance in at least three degrees of freedom, such that the coupling system can, within certain limits, absorb movements in all directions between two coupled-together vehicles.

Also, according to yet another preferred disposition of the present invention, and to make implementation easier, said protector means for protecting said coupling are suitable for passing from a folded position to a deployed position in which said coupling is surrounded by the protector means. The deployment movement and the return, folding movement can be controlled manually or automatically.

By way of example, the protector means may be of the bellows type, of the type having an optionally solid wall (possibly a grid), or presenting any other disposition that prevents access to the coupling system during and after the coupling procedure.

Advantageously, the protector means are situated at the rear of each vehicle and may present any of the following dispositions:
the protector means may be invisible in their folded position, e.g. being received in the rear of the vehicle;
the protector means may be of the shape that co-operates with the shape of the front of the vehicle so that the protector means form continuity at the front of the following vehicle situated behind the vehicle in question; and
the protector means may be connected to the coupling system, and in particular with the hitching bar, so as to move simultaneously when the coupling position passes from its retracted position to its extended position.

The vehicle preferably further includes means for covering the retracted coupling system, e.g. means in the form of one or more covers, so as to avoid access to portions of the coupling system that could lead to accidents.

Advantageously, provision is made for said covering means to comprise a cover suitable for surrounding the second portion or for closing the space containing the second portion of the coupling system when in its retracted position.

In addition, and advantageously, provision is also made for the vehicle also to include a software architecture that includes a coupling computer and an axle computer. In particular, provision is made for the vehicle also to present means enabling the coupling computer to be aware of the situation of the coupling system of said vehicle, in particular when a coupling is formed with another vehicle.

Preferably, said software architecture further includes a supervisor that makes it possible, via the coupling computer, to verify the locked position of the coupling between two vehicles, in order to issue a warning if said locked position is not engaged. These safety provisions make it possible to ensure that the coupling formed between the two vehicles does not present any problems.

The invention also provides a procedure for coupling together at least two vehicles of the type described above. The coupling procedure is characterized in that in that it comprises the following steps:

a) moving a first vehicle forming the leading vehicle into a docking location;

b) moving another vehicle forming a following vehicle so as to bring it into alignment behind the leading vehicle at a predetermined docking distance;

c) activating the second portion of the coupling system of the leading vehicle and the first portion of the coupling system of the following vehicle so as to form a coupling between them; and

d) activating the protector means for protecting said coupling system, situated at the rear of the leading vehicle in order to prevent any contact between the coupling and an element outside the vehicle train thus formed.

In the coupling procedure, it is possible to add an additional following vehicle by each additional following vehicle implementing additional steps corresponding to steps b) to d), and comprising:

b′) moving the additional following vehicle so as to put it in alignment behind the previously coupled following vehicle at a predetermined docking distance; then

c′) activating the second portion of the coupling system of the additional following vehicle and the first portion of the coupling system of the previously coupled following vehicle that precedes it so as to form an additional coupling between them; and

d′) activating the protector means for protecting said additional coupling, situated at the rear of the previously coupled following vehicle so as to prevent any contact between the additional coupling and an element external to the vehicle train thus formed.

In this way, it will be understood that it is easy to add an additional following vehicle at one or more different locations of the transport network, e.g. on a single transport route that is being operated, with this serving to satisfy the needs of higher-traffic zones.

In a preferred embodiment, the vehicle further includes a contactless guidance system that is particularly useful during step b) or b′) of moving the following vehicle during the coupling procedure. In particular, the contactless guidance system may operate using optical guidance, magnetic guidance, or electromagnetic guidance with pseudo-distances or by measuring phases, for example a satellite positioning system of the GPS or GALILEO or GLONASS type.

In particular, said contactless guidance system can make use of a reference trace on the road, together with obstacle detectors.

Thus, by using such a contactless guidance system, it is possible to ensure reliably that two vehicles are properly positioned relative to each other before they are coupled together, whether for adjusting the longitudinal distance between two vehicles before they are coupled together, or for ensuring they are properly in alignment so as to avoid any lateral offset or shift between them.

Concerning these aspects of automatic guidance and guidance on the ground, reference can be made for example to WO 98/47754, WO 99/14096, EP 0 919 449, and FR 2 766 782, or indeed to FR 2 780 696 which relates to an automatic guidance system on board a vehicle with a module enabling manual control to take over at will.

The present invention also provides a method of managing a network for transporting passengers and/or objects using vehicles of the type described above. This management method is characterized in that it implements the following steps:
driving at least two vehicles and/or vehicle sets coming from different origins (A, B, C, D, E, F, . . . ) towards one or more bifurcation poles (K, H, . . . ) of the network at the boundary between a high-traffic central zone (ZC) and a lower-traffic peripheral zone (ZP1, ZP2); and
performing, at said bifurcation pole, the above-defined coupling procedure between said vehicles to form a vehicle train having a single driver when said vehicles are going from the peripheral zone (ZP1, ZP2) towards the central zone (ZC).

The present invention also relates to a vehicle train formed by coupling together a plurality of vehicles of the type described above. The vehicle train is characterized in that comprises a single leading vehicle and at least one following vehicle situated behind the leading vehicle, said vehicles being connected together by said coupling, with contact between the coupling and an element external to the vehicles being prevented by said protector means.

Naturally, bifurcation poles may be situated in all of the zones, i.e. in particular in the central zone (ZC) and/or in the peripheral zones (ZP1, ZP2).

It will be understood that the vehicle train is made up of vehicles of the same type, which may nevertheless differ from one another in certain respects, including total vehicle length or length between axles, in particular between two steering axles, one at the front and the other at the rear.

The invention also relates to a procedure for uncoupling the last coupling of a vehicle train of the type defined above, and comprising at least one last following vehicle and a leading vehicle, the method being characterized in that it comprises the following steps:

a) activating the protector means of the last coupling situated between the last following vehicle and the vehicle preceding it so as to disengage said last coupling;

b) activating the second portion of the coupling system of the last following vehicle and the first portion of the coupling system of the vehicle that precedes it so as to undo the last coupling and retract said second portion of the coupling system, whereby the last following vehicle is separated from the vehicle train and forms an autonomous vehicle together with a train of remaining vehicles; and

c) moving said autonomous vehicle or the remaining vehicle train.

Advantageously, this uncoupling procedure further includes, after step b), an additional step in which said covering means of the last vehicle of the remaining vehicle train are activated to hide the retracted second portion of the coupling system.

In this way, it will be understood that it is easy at one or more different locations of the transport network, e.g. on a single transport route in service, to remove one of the following vehicles or all of the following vehicles, for the purpose of reducing the total length of the vehicle train so as to match it to the requirements of zones of lower traffic.

Furthermore, by symmetry, the present invention relates to a method of managing a network for transporting people and/or objects using vehicles of the type described above, which method is characterized in that it implements the following steps:
driving a vehicle train comprising at least two coupled-together vehicles towards a bifurcation pole (H, K, . . . ) of the central zone (ZC) of a network that comprises a high-traffic central zone (ZC) and a lower-traffic peripheral zone (ZP1, ZP2); and
implementing between said vehicles, at said bifurcation pole (H, K, . . . ), the above-defined uncoupling procedure for breaking up a single-driver vehicle train coming from the central zone (ZC) to obtain a plurality of individual autonomous vehicles and/or autonomous vehicle sets heading towards the peripheral zone (ZP1, ZP2) on different routes towards other stations (A, B, C, D, E, F, . . . ).

In addition, the present invention provides a method of managing a network for transporting people and/or objects using vehicles of the type described above, and characterized in that it implements the following steps:
driving at least two vehicles and/or vehicle sets to a bifurcation pole (K, H, . . . ) of the network at the boundary between a high-traffic central zone (ZC) and a lower-traffic peripheral zone (ZP1, ZP2);
at said bifurcation pole (K, H) coupling said vehicles together to form a vehicle train with a single driver when said vehicles are going from the peripheral zone (ZP1, ZP2) towards the central zone (ZC); or at said bifurcation pole (K, H) uncoupling said vehicles to break up a single-driver vehicle train coming from the central zone (ZC) to obtain a plurality of autonomous individual vehicles and/or autonomous vehicle sets heading towards the peripheral zone (ZP1, ZP2) along different routes.

Finally, the present invention provides a method of transporting passengers and/or objects by means of a set of same-type vehicles each having a driver's cabin, a space for transporting people and/or objects, a steering front axle, and a retractable coupling system enabling said vehicle to be coupled together one behind another to form a vehicle train comprising at least two vehicles, and enabling said vehicles to be separated from one another in order to form a plurality of autonomous individual vehicles and/or autonomous vehicle sets, with the coupling and uncoupling operations being performed at a bifurcation pole (H, K, . . . ) of a traffic network in the form of a tree structure or star structure, the bifurcation pole (H, K, . . . ) lying at the boundary between zones having different concentrations of people and/or objects.

In the context of the transport method, the method is preferably a passenger transport method and said vehicles are passenger transport buses.

In addition, in another preferred implementation of this method of transporting passengers and/or objects, the bifurcation pole is located in a star-shaped portion of the network, between a central zone (ZC) having a high concentration of passengers and/or objects, and a peripheral zone (ZP1, ZP2) having a low concentration of passengers and/or objects.

More advantageously, provision is made in this method of transporting passengers for said vehicles further to include means for protecting said coupling formed between two vehicles connected to each other, in order to prevent any contact between the coupling and an element external to the vehicles, and in particular in order to avoid injuring a passerby or a passenger.

Other advantages and characteristics of the invention appear on reading the following description made by way of example and with reference to the accompanying drawings, in which:

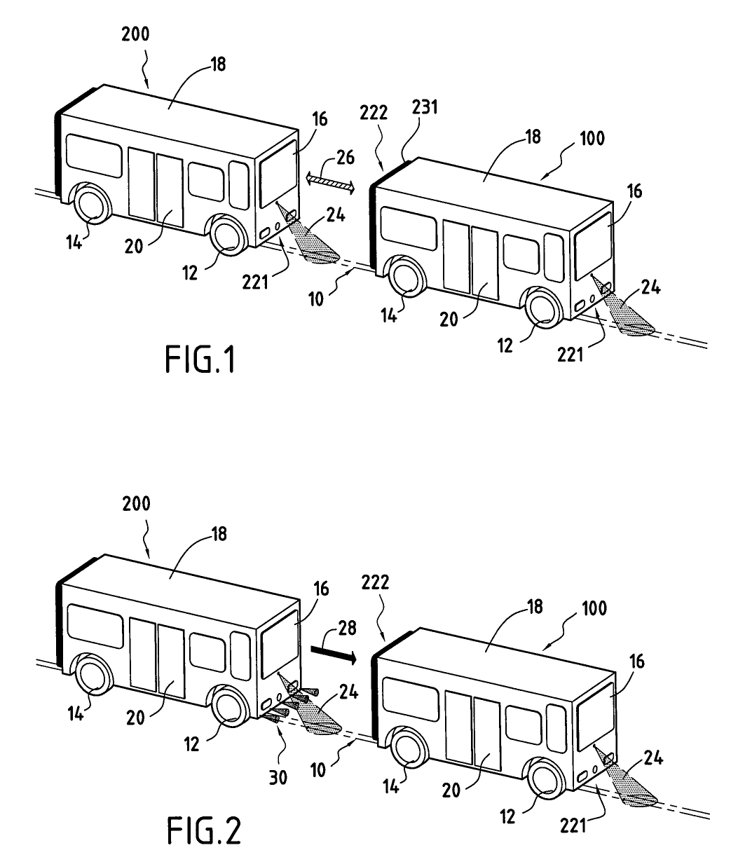

FIG. 1 is a diagrammatic perspective view of the first step of a method of coupling together two vehicles;

FIG. 2 shows the second step of the coupling procedure;

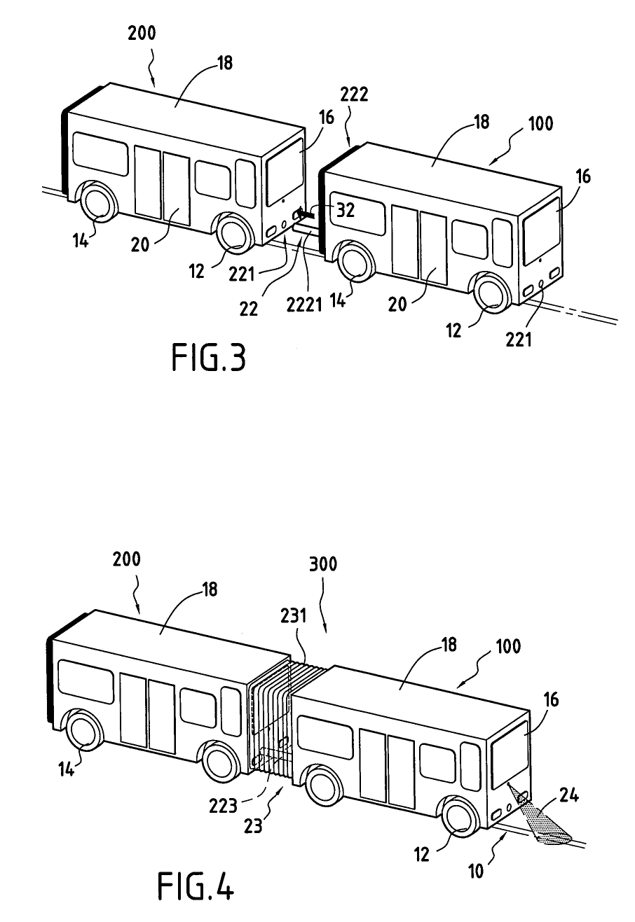

FIG. 3 shows the third step of the coupling procedure;

FIG. 4 shows the fourth step of the coupling procedure;

FIG. 5 is a diagram showing an example of a method of managing a transport network using vehicles of the present invention during a first vehicle movement during peak periods;

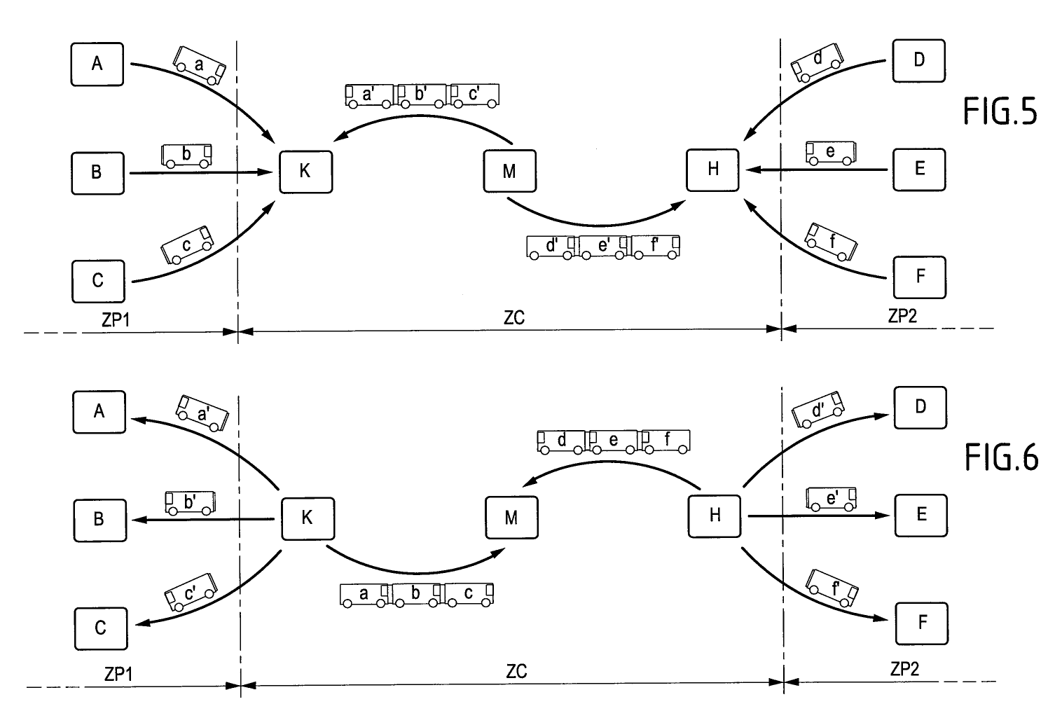

FIG. 6 is a diagram similar to that of FIG. 5 showing a second vehicle movement;

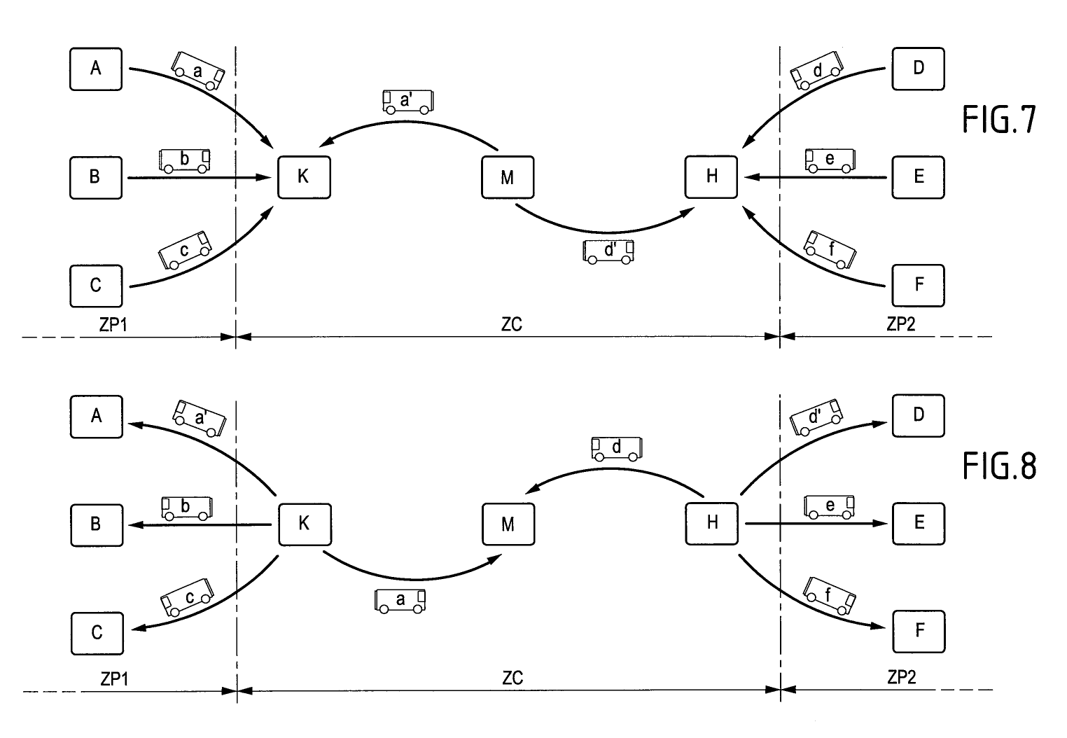

FIGS. 7 and 8 are similar to FIGS. 5 and 6, but for use during off-peak periods;

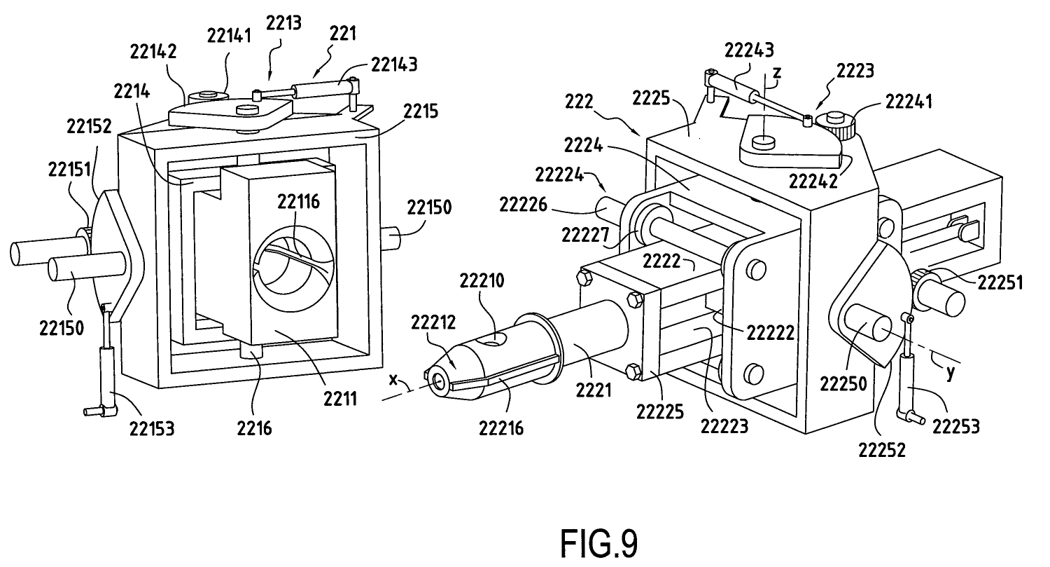

FIGS. 9 to 13 show an embodiment of the coupling system; and

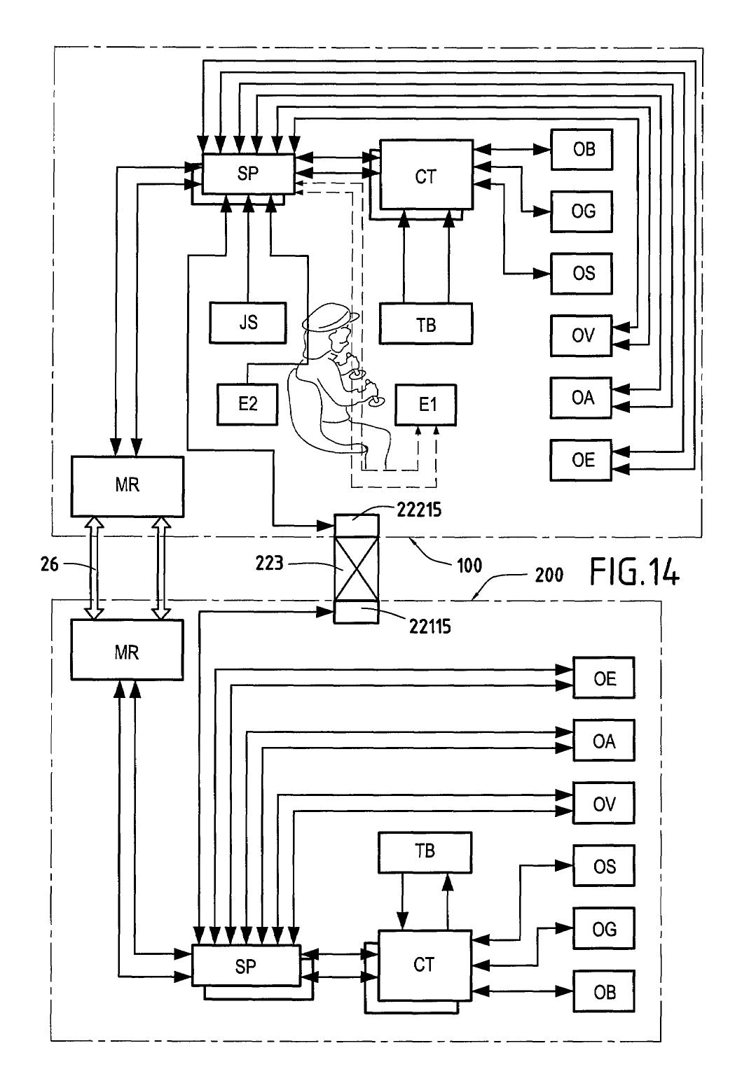

FIG. 14 shows the software architecture enabling communication to be performed during and after implementing the coupling procedure.

In FIG. 1, there can be seen two identical vehicles 100 and 200 placed one behind the other along a reference trace 10 disposed on the ground. The vehicles 100 and 200 are identical and present:
a front steering axle 12 of the rigid, semirigid, or independent-wheel type, controlled by the driver of the vehicle; and
a rear axle 14, preferably a self-steering axle, of the rigid, semirigid, or independent-wheel type, and servo-controlled by an automatic system.

When both the front and the rear axles of each vehicle are steering axles, the vehicles can have better maneuverability and tighter turning circles, and they can also present increased stability.

Furthermore, the space inside each vehicle is shared between a driver's cabin 16 at the front (to the right in FIG. 1) and a space 18 in the middle and at the rear (to the left in FIG. 1) for transporting passengers and presenting one or more automatic doors 20.

Each vehicle 100 and 200 further includes a coupling system 22 (see FIG. 13) disposed in the low portion of the bodywork and comprising a first portion 221 situated at the front of the vehicle (see FIG. 1), and a second portion 222 (see FIG. 1) situated at the rear of the vehicle and that remains retracted, and therefore not visible during periods in which the vehicles 100 and 200 are separated from each other and remain autonomous.

Each vehicle 100 and 200 also includes a contactless on-board guidance system co-operating with the reference trace 10. By way of example, in the figures, it is assumed that the vehicles 100 and 200 further present a guidance system that makes use of telemetry, and that for this purpose they present, at the front, one or more distance detectors associated with an optical guidance module, and also with detectors for detecting nearby obstacles (not shown).

When the two vehicles 100 and 200 are about to be coupled together in accordance with the coupling procedure of the present invention, each of the vehicles is directed towards a coupling station (which thus forms a bifurcation pole or an exchange pole, also serving as a passenger station or stop) where the reference trace 10 is to be found.

Initially, as can be seen in FIG. 1, the vehicle 100 that is to form the leading or head vehicle, is placed in alignment on the reference trace 10 by moving in guided mode, with the trace being read by corresponding detectors (read beam 24 in FIG. 1), with the vehicle 100 then being stopped along the reference trace 10.

Thereafter, the vehicle 200 comes up from behind, along the reference trace 10 (read beam 24 in FIG. 1) and then communication is established between the two vehicles 100 and 200 (see arrow 26 in FIG. 1 and in FIG. 14), the vehicle 100 communicating with the vehicle 200 to ask it to move forwards automatically after making sure that the vehicle 200 is safe, and in particular that its doors 20 are closed.

In the following step, as can be seen in FIG. 2, the rear vehicle 200 moves forwards (arrow 28 in FIG. 2) automatically, with or without a driver, making use of the optical guidance module (read beam 24) along the reference trace 10 and making use of the detectors of nearby obstacles (beam 30 in FIG. 2) in order to be aware at any moment of the possible insertion of an object or a person between the front vehicle 100 and the rear vehicle 200 so as to be able to stop this approach maneuver momentarily, should that be appropriate.

This approach maneuver continues until the vehicle 200 reaches a distance from the head vehicle 100 that is predetermined and that has been programmed into the guidance system. It should be understood that this predetermined distance is shorter than the maximum longitudinal displacement of the hitching bar 2221.

In the following step, as can be seen in FIG. 3, a stage of hitching between the two vehicles 100 and 200 is begun.

Previously, and where appropriate, since this is an optional variant, a protective cover (not shown) placed in front of the second portion 222 of the coupling system 22 level with the bodywork 100a (see FIG. 11), is moved into an open position so as to disengage the outlet for the hitching bar 2221.

During this hitching stage, the coupling system 22 of the two vehicles 100 and 200 is activated. More precisely, the second portion 222 of the coupling system of the front vehicle 100 passes from its first or retracted position, in which it is not visible, into its second or extended position in which a telescopic hitching bar 2221 is extended (arrow 32 in FIG. 3) out from the bodywork 100a and becomes engaged in a corresponding locking member 2212 of the first portion 221 of the coupling system 22 of the rear vehicle 200 (see FIGS. 9 to 12).

After establishing co-operation between the second portion 222 of the coupling system 22 of the front vehicle 100 with the first portion 221 of the coupling system of the rear vehicle 200, a complete coupling 223 is set up (see FIGS. 4, 11, and 14).

A more precise example of the coupling system suitable for use is described below with reference to FIGS. 9 to 13.

From this point on, it will be understood that a single driver is necessary and sufficient for continuing the operations, and in particular for driving the vehicle train 300 made up by the two vehicles 100 and 200 at the end of the coupling procedure.

In order to make the coupling 223 secure, i.e. to avoid it being accessible to people (or objects) that might be injured (damaged) by striking the coupling 223 and becoming jammed between the two vehicles 100 and 200, in particular when moving one or both vehicles 100 and 200, protector means 23 are provided for protecting the coupling 223.

For this purpose, and by way of preferred example, provision is made for said protector means 23 to comprise a bellows 231 situated at the rear of the vehicle and capable, in the deployed position, of surrounding said coupling 223. Additional explanations are given below with reference to FIGS. 9 to 13.

Thus, the bellows 231 forms a concertina-like protective skirt suitable for deforming when the front vehicle 100 and the rear vehicle 200 are no longer parallel with each other, i.e. when negotiating a turn.

In a preferred disposition (see FIG. 11), the free end 2311 of said bellows 231 is connected, via a frame and a rodding system ball-mounted at its end, to said hitching bar 2221 in order to follow the forward or reverse movement of the hitching bar 2221: thus, the bellows 231 is deployed or refolded simultaneously with the longitudinal movement of the hitching bar 2221, without it being necessary to perform any other operation, and in particular without it being necessary to fasten the free end 2311 of the bellows 231.

At this stage, at the end of the hitching process, the coupling 223 present between the front vehicle 100 and the rear vehicle 200 has formed a vehicle train 300 that is capable of moving as a single unit under control from the single driver's cabin 16 of the front vehicle 100, which vehicle thus forms a leading vehicle, as compared with the rear vehicle 200 which forms a following vehicle, without a driver.

For this purpose, provision is made for the vehicles 100 and 200 also to present a system for recovering steering data from the wheels of the leading front vehicle 100 by the coupling 223 reading the displacement of a gearwheel 22141 so as to enable the following, rear vehicle 100 to track the leading vehicle 100 by making use of the steering information. This means that steering setpoints (for the front and rear axles) are given to the following vehicles 200, which setpoints correspond to the steering of the leading vehicle 100. Alternatively, only the steering of the front axles of the following vehicles are controlled, in which case each following vehicle is allowed to become offset relative to the preceding vehicle. The system for recovering data is described in greater detail below with reference to the software architecture shown in FIG. 14.

Under such circumstances, provision is also advantageously made for the vehicles 100 and 200 also to present a system for replicating controls and information from the driver's cabin 16 between the leading vehicle 100 and the following vehicle 200, via the coupling 223. Amongst these controls and information from the driver's cabin that are transmitted from the following vehicle 200 towards the leading vehicle 100, or vice versa, it is possible to include all of the information and controls relating to position, driving, or inside or outside signaling, regardless of whether the information is electrical, analog or digital, pneumatic, or of any other kind.

In a variant of the procedure that is not shown, instead of the above explanations concerning the first steps of FIG. 1, it is necessary to make provision for circumstances in which it is the following vehicle 200 that is the first to arrive at the coupling station or bifurcation pole for coupling purposes, i.e. before the leading vehicle 100.

Under such circumstances, initially, the vehicle 200 that is to become the following vehicle, is aligned on the reference trace 10, by being moved in guided mode, with said trace being read using the corresponding detectors (read beam 24), and then the vehicle 200 is stopped in its location.

Thereafter, the vehicle 100 comes up from behind and overtakes the vehicle 200 and then likewise takes up a position on the reference trace 10 (read beam 24) in front of the vehicle 200. It communicates with the vehicle 200 to request it to advance automatically after making sure that the vehicle 200 is secure, i.e. in particular that its doors 20 are closed. Thereafter the operations proceed using the steps shown above with reference to FIG. 2.

In another variant implementation (not shown), the driver's cabin 16 can be transformed into passenger space 18, in particular by shutting off access to the controls of the driving seat, for example by shutting off access to the door beside the driver.

Although the description above corresponds to circumstances in which the leading and following vehicles 100 and 200 are identical, it must be understood that the above-described coupling procedure can be applied to vehicles that are similar, differing between one another only in total length and/or length between front and rear axles 12 and 14, for example, or indeed presenting one or more additional intermediate axles.

In the same way, it will be understood that it is possible at the same location or after the two-vehicle train has moved onto another coupling location, to apply the same procedure for coupling another additional vehicle behind the following vehicle 200 so as to form a vehicle train comprising more than two similar vehicles (of identical or different lengths).

In all such circumstances, the vehicle train 300, like each non-coupled individual vehicle 100 or 200, is capable of traveling in autonomous mode (solely under the control of the driver of the front vehicle 100 taking control manually) or in guided mode (from the automatic guidance system of the vehicle 100).

In order to implement the procedure for uncoupling the previously-formed coupling 223, the same steps are performed in the opposite order, at a coupling station or bifurcation pole. More precisely, the sequence of steps is simplified since the process starts from an initially coupled position in which the vehicles 100 and 200 start by being connected to one another, but it is nevertheless preferable to seek good alignment between the two vehicles for uncoupling.

Thus, the initial position of the uncoupling procedure corresponds to the situation shown in FIG. 4.

Thereafter, during a first step of the uncoupling procedure, the locking between the hitching bar 2221 of 4 the second portion 222 of the coupling system 22 of the front vehicle 100 and the locking member 2212 of the first portion 221 of the coupling system of the rear vehicle 200 is undone prior to retracting the hitching bar 2221 so that it penetrates into (or under) the rear portion of the bodywork 100a of the front vehicle 100, corresponding to its retracted position. During this maneuver of retracting the hitching bar 2221, the free end 2311 of the bellows 231 is simultaneously moved back so that it folds against the rear of the front vehicle 100.

Thereafter, where appropriate, the protective cover is reclosed, being placed over of the second portion 222 of the coupling system 22 of the front vehicle 100 so as to prevent extension of or access to the hitching bar 2221.

Thus, at the end of the above-described uncoupling procedure, the train of vehicles 300 has been undone and each of the two vehicles 100 and 200 becomes autonomous again, on its own, and is capable of going away under the control of one driver per vehicle following routes that can now be different.

The coupling procedure, like the uncoupling procedure, is implemented, by way of example but not necessarily, at a location constituted by a site that is protected by fencing, such coupling locations or stations constituting or being situated close to or in bifurcation poles or nodes (A; B; . . . ; M) of a traffic network. Such traffic networks may be in the form of a tree-shaped or star-shaped structures, with said coupling locations or stations being located between zones for concentrating passengers and/or different objects. When transporting passengers, provision can be made for a platform to be present at the location where passengers embark and/or disembark, this location being separate from or physically the same as the bifurcation pole.

Reference is now made to FIGS. 5 to 8 which show by way of example how the above-described coupling and uncoupling procedures can be implemented in the context of managing a network for transporting passengers and/or objects, the network presenting differing concentrations of passengers and/or objects.

FIGS. 5 to 8 show a portion of such a network that comprises a central zone ZC of high traffic situated between two peripheral zones of lower traffic, respectively ZP1 and ZP2.

In the central zone ZC there are three successive bifurcation poles K, M, and H that are common to three transport lines and that constitute passenger stations in this example. In the peripheral zone ZP1 there are three stations A, B, and C each forming the station following station K on each of three respective transport lines. In the peripheral zone ZP2 there are three stations D, E, and F, each forming the station that follows the station H on each of three respective transport lines.

In this example, use is made of twelve identical vehicles a to f and a′ to f′, each of the same type as the above-described vehicles 100 and 200. These vehicles a to f and a′ to f′ present a size Y corresponding to small capacity for passengers.

In the first configuration, shown in FIGS. 5 and 6, consideration is given to managing the fleet of vehicles a to f and a′ to f′ during peak periods, with the traffic being particularly heavy between the stations K, M, and H of the central zone ZC.

At an instant T in the schedule, the vehicles a to f are parked respectively at stations A, B, C, D, E, and F in the peripheral zones ZP1 and ZP2. The coupled vehicle trains a′+b′+c′ and d′+e′+f′ each made up of three vehicles of size Y are parked at the station M in the central zone ZC.

A first movement in the schedule from this instant T is shown in FIG. 5.

At the following instant, correspond to the end of this first movement in their schedule, the vehicles a, b, and c stop at the station K where they are coupled together to form another three-vehicle train a+b+c, the vehicles d, e, and f reach the station H where they are coupled together to form another three-vehicle train d+e+f. At the same time, the two three-vehicle trains a′+b′+c′ and d′+e′+f′ are parked respectively in the station K and the station H where they are completely uncoupled so as to release each of the vehicles a′, b′, c′, d′, e′, and f′ individually. Thereafter, the second movement of the schedule is carried out as can be seen in FIG. 6.

At the following instant, which corresponds to the end of this second movement in the schedule, the vehicles a′, b′, c′, d′, e′, and f′ are parked respectively at the stations A, B, C, D, E, and F in the peripheral zones ZP1 and ZP2, and the coupled vehicle trains a+b+c and d+e+f are parked at the station M in the central zone ZC.

It will be understood that by continuing this scheduled movement of the buses, at the end of the following movement (third movement (not shown)), the coupled vehicle trains a+b+c and d+e+f are parked respectively at the station H and at the station K of the central zone ZC. Thereafter, these vehicle trains are uncoupled at these locations and the buses move away individually so that at the end of the following movement (fourth movement (not shown)), the vehicles a, b, and c are parked respectively at the stations D, E, and F in the peripheral zone ZP2.

Four more movements of the schedule are still required in order to return to the starting configuration for the complete cycle (these movements taking place in the manner explained above but with the vehicles a, b, c, d, e, and f being replaced by the vehicles a′, b′, c′, d′, e′, and f′, and vice versa).

Thus, at peak periods, there are twelve identical buses a to f and a′ to f′ permanently in operation together with eight drivers, while a passenger seeking to go from station A to station H, or vice versa, will not need to change vehicle since it is entirely possible to remain in the same vehicle, which will go on to one of the end stations in the zone ZP2.

In addition, it will be understood that during peak periods, at each station there is always one bus arrival and one bus departure, so passengers move quickly.

In a second configuration, shown in FIGS. 7 and 8, attention is given to managing the fleet of twelve vehicles ato f and a′ to f′ during off-peak periods, i.e. at times of day when the traffic in the central zone ZC is less heavy and when the presence of a single autonomous vehicle is sufficient in the central zone ZC between two of the three stations K, M, and H.

Under such circumstances, only eight of the twelve vehicles of the fleet are in use simultaneously, being constituted by the vehicles ato f and a′ to d′, while the other vehicles b′, c′, e′, and f′ are on standby or are used in other zones of the transport network.

At instant T in the schedule, the vehicles a to f are parked respectively at stations A, B, C, D, E, and F in the peripheral zones ZP1 and ZP2, the uncoupled vehicles a′ and d′ are parked at the station M, while the other uncoupled vehicles (b′, c′, e′, and f′) are parked at points in the network.

A first movement of the schedule from this instant T is shown in FIG. 7.

At the following instant, corresponding to the end of this first movement in the schedule, the uncoupled vehicles a, b, c, and a′ are parked at the station K in the central zone ZC and the uncoupled vehicles d, e, f, and d′ are parked at the station H of the central zone

Thereafter, a second movement of the schedule is performed as can be seen in FIG. 8.

At the following instant, corresponding to the end of this second movement of the schedule, the uncoupled vehicles b and c and the uncoupled vehicles e and f have returned to park at their preceding positions, respectively the stations B, C, E, and F in the peripheral zones ZP1 and ZP2 while the uncoupled vehicles a and a′ and d and d′ have crossed in the stations K and H respectively of the central zone ZC so that these four vehicles a, a′, d, and d′ are now parked respectively at the stations M, A, M, and D.

This schedule is continued in the same manner with the uncoupled vehicles a, a′, d, and d′ traveling along the portion of the network that extends between two ends (stations A and D) of the network and thus covering both peripheral zones ZP1 and ZP2 and also the central zone ZC. In parallel, uncoupled vehicles b, c, e, and f shuttle between pairs of stations (respectively B and K, C and K, E and H, F and H), one of these two stations lying at the boundary of the central zone ZC and the other of these two stations lying at the boundary of a peripheral zone ZP1 or ZP2.

Thus, during off-peak periods, eight buses and eight drivers are continuously in operation, and a passenger seeking to go from station A at least as far as station M or even station H, or vice versa, will not need to change vehicle and can stay in the vehicle a or a′ (d or d′ depending on the position in the schedule). However, a passenger seeking to go from station B in peripheral zone ZP1 to station E in peripheral zone ZP2 will need to change vehicles both at K and at H, and the boundaries of the central zone ZC.

In this configuration, it will be understood that during off-peak periods, there are fewer trips and therefore longer waits at each station.

This type of network combines numerous advantages.

Thus, use is made of vehicles of small size Y corresponding to demand at peak periods on the central portion by coupling the vehicles together, while nevertheless limiting the number of drivers and vehicles of larger size. Passengers do not need to change vehicle (load breaking) for trips undertaken during peak periods.

During off-peak periods, the number of vehicles traveling on the network is limited, both in the central zone ZC and in the peripheral zones ZP1 and ZP2 (better energy effectiveness). Similarly, a uniform fleet of vehicles is available, thus greatly facilitating training (of drivers and mechanics), maintenance, and management of this fleet of vehicles.

Naturally, in a variant (not shown) it is possible to envisage managing the vehicles with a solution that is intermediate between the first circumstances shown in FIGS. 5 and 6 and the second circumstances shown in FIGS. 7 and 8, in which the central zone ZC has trains of two coupled-together vehicles traveling therein.

Reference is now made to FIGS. 9 to 13 which show one possible embodiment for the coupling system 22.

As can be seen in FIGS. 9 to 11, in the first portion 221 of the coupling system 22 of the rear vehicle 200, situated at the front of said vehicle 200, there is provided a part 2211 presenting a funnel-shaped housing forming a guide with a shallow bottom suitable for receiving the end portion 22212 of the hitching bar 2221.

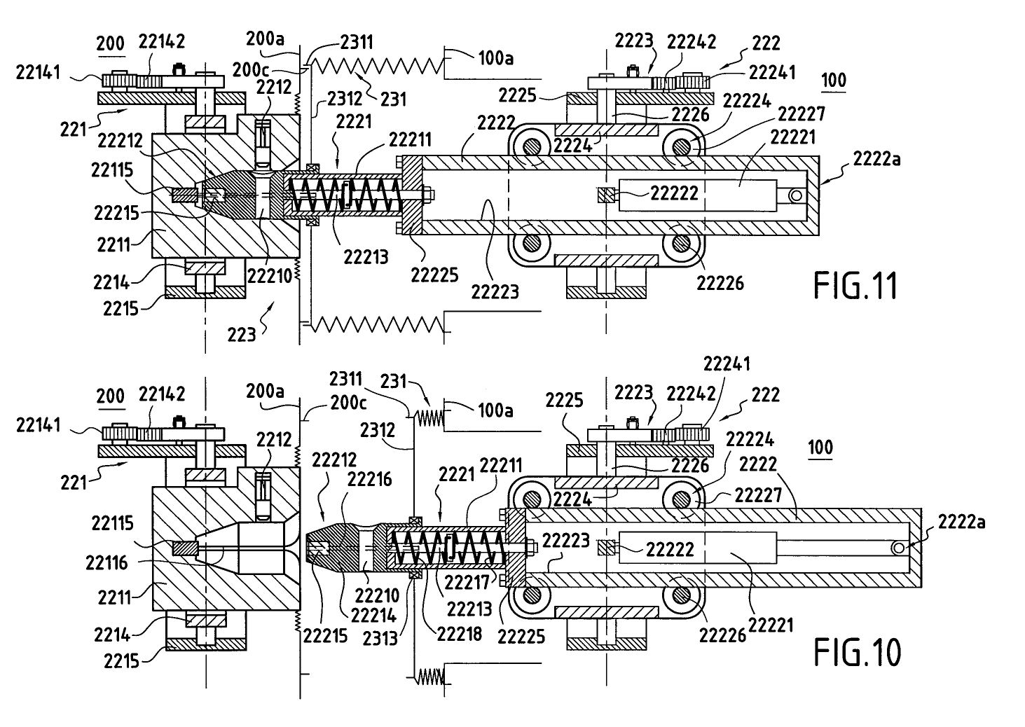

A locking member 2212 (see FIGS. 10 and 11) constituted by a remotely-controllable pin, e.g. under pneumatic control, is housed in the part 2211 and can go from a retracted position (FIGS. 10 and 11) to an extended position (not shown) in which it co-operates with an eye 22210 situated in the end portion 22212 of the hitching bar 2221 to lock the resulting coupling 223 mechanically.

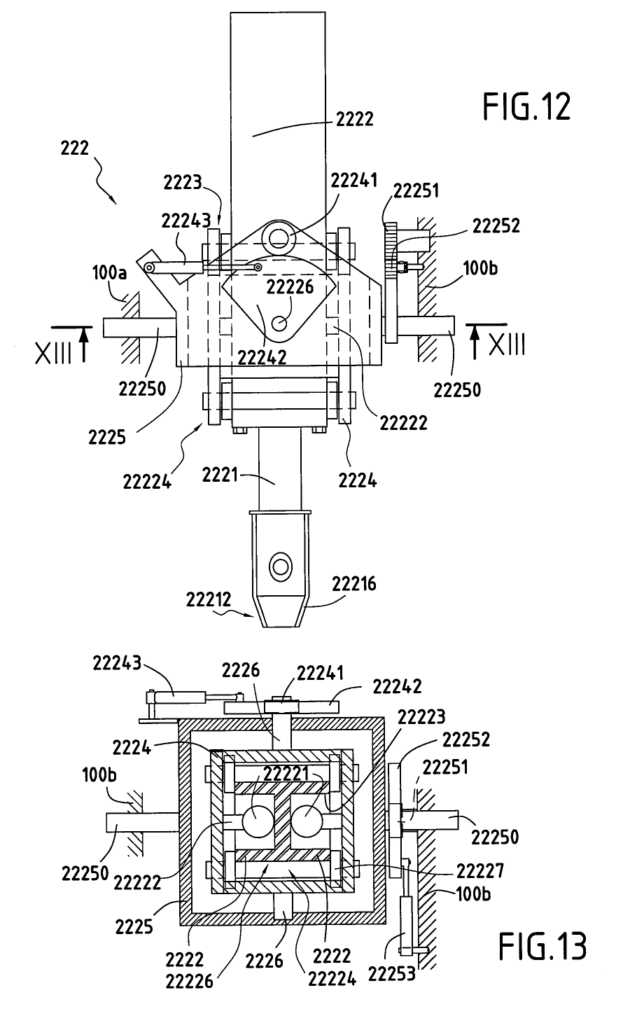

For the second portion 222 of the coupling system 22 in the front vehicle 100, situated at the rear of said vehicle 100, the hitching bar 2221 which extends in the longitudinal horizontal direction parallel to the X axis, is mounted at the end of a sleeve 2222 which connects it to an articulated system 2223, itself connected to the chassis 100b of the vehicle 100 (see FIG. 12).

The articulated system 2223 comprises a first frame 2224 and a second frame 2225 that are engaged one in the other and that surround the sleeve 2222, thus making it possible for the sleeve 2222 to move in rotation together with the hitching bar 2221 about the vertical direction parallel to the Z axis (yaw movement), and about the transverse horizontal direction parallel to the Y axis (pitching movement).

More precisely, the inner, first frame 2224 is placed inside the outer, second frame 2225 and is connected thereto by two vertical rod segments 2226 rigidly mounted to the first frame 2224 and pivotally mounted relative to the second frame 2225. This vertical rod 2226 can be caused to turn about the vertical direction parallel to the Z axis by a first assembly comprising a gearwheel 22241 and a toothed sector 22242, the movement of the toothed sector 22242, which is pivotally mounted relative to the second frame 2225, being controlled by an actuator 22243 connected to the toothed sector 22242 and to the second frame 2225, while the toothed sector 22242 is secured to the end of the rod 2226.

Furthermore, the second frame 2225 is movable in pivoting about the transverse horizontal direction parallel to the Y axis by means of two lateral extensions 22250 (FIGS. 9, 12, and 13) forming shafts mounted to pivot relative to the chassis 100b. These two lateral extensions 22250 are secured to the second frame 2225 and they can be caused to pivot about the transverse horizontal direction parallel to the Y axis by a second assembly comprising a gearwheel 22251 and a toothed sector 22252, the movement of the toothed sector 22252 being controlled by an actuator 22253 mounted on the chassis 100b, while the toothed sector 22252 is secured to the end of one of the two lateral extensions 22250 (see FIGS. 9 and 13).

To enable the hitching bar 2221 to be deployed reversibly in the longitudinal direction, and to give a third degree of freedom to the articulated system 2213, two actuators 22221 are used that are mounted in parallel in the sleeve 2222 and that, in the embodiment shown, present a cross-section that is I-shaped (see FIG. 13). The cylinders of these two actuators 22221 are connected to the inner frame 2224 by means of a square section transverse pin 22222 that is advantageously connected to the cylinder of the corresponding actuator via a pivot or ball type joint (not shown). The square section transverse pin 22222 passes through a lateral opening 22223 in each of the two side walls of the sleeve 2222. The rods of these two actuators 22221 are connected to the end wall of the sleeve 2222 via pivot type joints 2222a.

To enable the sleeve 2222 to be guided longitudinally relative to the frame 2224, the actuators 22221 are used to cause the sleeve 2222 to slide on rolling assemblies 22224 mounted in pairs at the front and the rear of the frame 2224, above and below the sleeve 2222, each rolling assembly comprising a transverse roller 22226 whose ends are pivotally mounted relative to the frame 2224, and a pair of wheels 22227.

At this stage, it should be observed that the actuators 22221 thus serve not only to control the movement of the hitching bar 2221 during the coupling or uncoupling procedure, but they also make it possible within a coupled coupling 223 to absorb a certain amount of longitudinal displacement of the hitching bar 2221, thus causing them to act as shock absorbers that would not be present in a rigid hitch that would need to absorb jolts mechanically during travel of the vehicle train 300.

In order to allow a certain amount of freedom in rotation at the free end of the hitching bar 2221, it is made up of two functional portions that are capable of turning relative to each other about the longitudinal direction. There is a tube 22211 connected rigidly to the free end of the sleeve 2222 extending the front wall 22225 of the sleeve 2222. The hitching bar 2221 also has an end portion 22212 including the eye 22210. The end portion 22212 is secured to a rear rod 22213 housed inside the tube 22211 and mounted to turn relative to the front wall 22225 of the sleeve 2222.

Two springs 22217 and 22218 are mounted in opposition, being secured firstly to the rod 22213 and secondly, either to the front wall 22225 or to the tube 22211, thus generating a return force tending to bring the hitching bar 2221 into the same angular orientation about the longitudinal direction.

The end portion 22212 surrounds a front portion of the tube 22211 with a rear portion in the form of a sleeve that terminates in a shoulder: it is at this location that a ring 2313 is mounted to perform a function that is described below in association with the bellows 231.

The end portion 22212 is extended outside the tube 22213 by a hitching head 22214 corresponding to the eye 22210 and a first connector portion 22215 at the free end of the hitching head 22214.

This first connector portion 22215 is for coming into co-operation with a second connector portion 22115 disposed in the bottom of the part 2211 (see FIGS. 10 and 11) so as to provide an electrical connection, e.g. of the multiplex type, and thus communication between the two vehicles 100 and 200 via the coupling 223, as described below with reference to FIG. 14.

These first and second connector portions 22215 and 22115 can also constitute systems for putting the two portions of the coupling 223 into alignment or auto-alignment.

In order to facilitate proper relative angular positioning between the first connector portion 22215 and the second connector portion 22115, the hitching head 22214 is provided on the surface of its end with a pair of splines 22216 (see FIG. 9) suitable for co-operating with a corresponding pair of guide grooves 22116 formed inside the part 2211. This pair of guide grooves 22116 forms a guide ramp for bringing each spline 22216 firstly into the proper orientation about the longitudinal direction parallel to the X axis, and secondly for maintaining the orientation during the end of the longitudinal displacement of the hitching bar 2221 until reaching the coupled position where the locking member 2212 co-operates with the eye 22210.

Furthermore, in order to absorb any movement of the coupling 223, the first portion 221 of the coupling system 22 includes an articulated system 2213 similar to the articulated system 2223 of the second portion 222 as described above.

More precisely, the part 2211 is mounted in an inner first frame 2214 housed in an outer second frame 2215 via an articulated joint, similar to that between the frames 2224 and 2225 so as to enable the guide part 2211 to turn about the vertical direction parallel to the Z axis (yaw movement) and about the transverse horizontal direction parallel to the Y axis (pitching movement).

More precisely, the inner first frame 2214 is placed inside the outer second frame 2215 and is connected thereto by two vertical rod segments 2216 rigidly mounted to the first frame 2214 and pivotally mounted relative to the second frame 2215. This vertical rod 2216 can be caused to pivot about the vertical direction parallel to the Z axis by a first assembly comprising a gearwheel 22141 and a toothed sector 22142, the movement of the toothed sector 22142, which is mounted to pivot relative to the second frame 2215, being controlled by an actuator 22143 connected to the toothed sector 22142 and to the second frame 2215, the toothed sector 22142 being secured to the end of the rod 2216.

Furthermore, the second frame 2215 is movable in pivoting about the transverse horizontal direction parallel to the Y axis, by means of two lateral extensions 22150 (FIG. 9) forming shafts mounted to pivot relative to the chassis 200b. These two lateral extensions 22150 are secured to the second frame 2215 and they can be caused to pivot about the transverse horizontal direction parallel to the Y axis by a second assembly comprising a gearwheel 22151 and a toothed sector 22152, with movement of the toothed sector 22152 being controlled by an actuator 22153 mounted on the chassis 200b, while the toothed sector 22152 is secured to the end of one of the two lateral extensions 22150 (see FIG. 9). Such a coupling system 22 enables a limited amount of clearance to be conserved in all three possible directions of displacement between the two vehicles 100 and 200 of the vehicle train 300, i.e. yaw, pitching, and roll.

FIGS. 10 and 11 also show the bellows 231 of the second portion 222 of the coupling system 22 of the front vehicle 100 passing from its folded position in FIG. 10 to its deployed position in FIG. 11 in which its free end 2311, which has followed the longitudinal advance movement of the hitching bar 2221, comes into position against a reception zone 200c of the bodywork 200a of the rear vehicle 200, said zone being of complementary shape and contact taking place via a frame supporting the free end 2311 and connected by a ball-mounted rodding system 2312 at its end to the hitching bar 2221 via a grooved ring 2313, of the ball bearing ring type. Thus, while it is being deployed, the free end 2311 of the bellows 231 retains the proper orientation for being received in the reception zone 200c of complementary shape in the bodywork 200a of the rear vehicle 200.

Advantageously, this ring 2313 can open and move away around the hitching head 22214 so as to make it possible in the retracted position to ensure that the hitching bar 2221 does not project outside the bodywork 100a.

The above-described coupling system 22 constitutes one possible embodiment of the invention and is a coupling system of mechanical type. Nevertheless, in the context of the present invention, the mechanical coupling system 22 could be associated with a coupling of virtual type (not shown) that is used as the main coupling, with the coupling system 22 acting as an alternative solution in the event of a problem. In another option, the virtual coupling is used as a secondary coupling in the event of a problem with the mechanical coupling system 22 which is then used as the main coupling system. The term “virtual” coupling system is used to mean the leading vehicle 100 controlling one or more following vehicles 200 without any physical link between the vehicles 100 and 200.

Reference is now made to FIG. 14 which shows the software architecture that can be used for exchanging information and controls between the vehicles during and after the coupling operation.

Advantageously, and as described above, the proposed coupling system enables data to be transferred between the vehicles 100 and 200 by means of the connector portions 22115 and 22215 integrated in the coupling 223.

It is also possible, in optional manner, to make use of a “wireless” communication system by radiowaves or by any other wireless communication means. In any event, it is preferred for communication to be made secure by being encrypted.

Between the vehicles 100 and 200 situated close together one behind the other, provision is made for intercommunication even when they are not coupled together, and in particular during the preliminary stage of establishing the coupling proper: under such circumstances, before a physical link has yet been established, it is by radiowaves between the radio modules MR that communication is made possible.

Each vehicle 100 and 200 has the same software architecture, however in FIG. 14, there are shown the portions of the vehicles 100 and 200 that are coupled together, and as used more particularly in the context of the invention.

Firstly, there can be seen elements that already exist in certain transport vehicles, in particular a controller CT connected to the dashboard TB from which it receives commands and to which it transmits information coming from the on-board computer OB and from the guidance computer OG, and possibly from a safety computer OS.

The on-board computer OB is connected to the three multiplexed networks of the vehicle (generally using a network communications protocol of the CAN SAE J1939 type) from which it receives and to which it transmits information, i.e.:
the multiplexed signaling network comprising in particular information concerning the states of lights and other audible or visible signaling means, such as warning lights;
the multiplexed chassis network that includes in particular state information (open or closed) concerning the front and rear doors; and
the multiplexed transmission system network including in particular information concerning the states of the engine, the gearbox, and of the brakes.

The guidance computer OG manages information from all of the guidance members including the position of the steering wheel and/or of the front axle 12 representative of the steering of the vehicle in question, information coming from cameras, such as cameras placed at the doors of the coupled-together vehicles and also at the back of the vehicle 100 and/or at the front of the vehicle 200, and if possible level with the coupling 22, or from any other guidance means, such as an optical or radio system.

The safety computer OS is connected in particular to the obstacle detectors situated at the front of the vehicle (beam 30 in FIG. 2).

It may be considered that the on-board computer OB, the guidance computer OG, and the safety computer OS form modules that are referred to as “non-critical” and that may be present in conventional vehicles.

Secondly, there are elements that are specific to the system in accordance with the invention, and including:
a coupling computer OA which at all times knows the position of the coupling 223 that has been established or that is being established between the leading vehicle 100 and the following vehicle 200, i.e.:
for the rear portion of the vehicle: the longitudinal advance position of the hitching bar 2221, the pitch position (upward or downward inclination relative to the horizontal), the yaw position (left or right inclination relative to the vertical) of the hitching bar 2221, and it actuates the toothed sectors 22252 and 22242 by means of the actuators 22253 and 22243;
for the front portion of the vehicle: it knows the position of the locking member 2212 (latch) and it actuates the toothed sectors 22142 and 22152 by means of the actuators 22143 and 22153; and
verifying the connected or non-connected situation between the connector portions 22115 and 22215;
an axle computer OE that knows at all times the angular position of the front axis 12 and the angular position of the rear axle 14;
a display computer OV connected to the inside and/or outside cameras such as a camera placed outside and behind the vehicle and facing rearwards, a camera viewing the open or closed state of the front door, and a camera viewing the open or closed state of the rear door. These images from all of the vehicles making up a vehicle train are accessible to the driver of the leading vehicle 100 on a screen E1 connected to the internal cameras (viewing the doors of all of the vehicles), and via a screen E2 connected to the external cameras (viewing the rear of the leading vehicle 100 and the front of the following vehicle 200 while coupling is taking place); and
a supervisor SP forming a vehicle integrity control computer, a data security computer, and an action filtering computer, is connected to the controller CT and to a manual control, e.g. in the form of a joystick JS, which enables the advance of the additional following vehicle 200 to be controlled during coupling and enables the orientation of the hitching bar 2221 to be corrected during coupling.

The supervisor SP is also connected to the first connector portion 22115 of the front, first portion 221 of the coupling system 22, and to the second connector portion 22215 of the rear, second portion 222 of the coupling system 22.

Furthermore, the supervisor is connected to the viewing computer OV, to the coupling computer OA, and to the axle computer OE.

In particular, the axle computer OE informs the supervisor SP about the type of servo-control between the axles 12 and 14 of the leading vehicle 100 and the axles 12 and 14 of the following vehicle 200, with this type of servo-control (tracking or non-tracking, for example) possibly being modified under the control of the supervisor SP.

Thus, it is possible to consider that the viewing computer OV, the coupling computer OA, and the axle computer OE form parts of modules that are referred to as “critical” and that are specific to vehicles in accordance with the invention. As can be seen from the above explanations, the particular function of these modules is to prepare the vehicles 100 for the coupling procedure, in particular by assisting in docking during the approach stage and also during the stage in which the resulting vehicle train 300 is being driven in the coupled state.

It should be understood that the controller CT forms an on-board computer for the actuators, and more particularly that it constitutes a portion of the software that normally manages all of the members, i.e. that verifies the states of the various members of the vehicle and that authorizes a control action requested from the dashboard by the driver, in particular when each vehicle 100 and 200 is autonomous, and, for the leading vehicle 100, once coupling has been achieved with the following vehicle 200.

In particular during the coupling procedure, the supervisor, which has priority over the controller CT, takes into consideration requests from the driver (such as those coming from the accelerator pedal, the brake, the steering wheel, from the gear shift, from a door-opening button, etc.) and verifies that the request (e.g. a request to cause the rear vehicle 200 to move forward) is compatible with the situation of the various members about which the controller is informed via the various computers OB, OA, OG, and OS.

In this architecture, the leading vehicle 100 is a master vehicle and any following vehicle 200 is a slave vehicle.

As can be seen in FIG. 14, it should be observed that for safety reasons, some of the wire connections are duplicated, as are likewise the supervisor computer SP and the controller computer CT.

It should be observed that the coupling system and the coupling procedure described herein differ from those used on railways in particular by the fact that unlike the rail-car sets of certain trains that are symmetrical between front and rear, here the particular feature of road vehicles is conserved in that they present a privileged forward direction and only one control cabin, which is situated at the front of the vehicle. In addition, unlike railways, the vehicles end up working in different planes, given that roads are not rectilinear and given the misalignment of the vehicle.

1. An autonomous wheeled vehicle provided with a driver's cabin and a space for transporting passengers, objects, or both passengers and objects, the vehicle comprising:
a front steering axle;
a retractable coupling system comprising a first portion situated at the front of the vehicle and a second portion situated at the rear of the vehicle, the first portion of a following vehicle being suitable for co-operating with the second portion of a leading vehicle, when the coupling system is extended, in order to connect the vehicles together by forming a coupling between them; and
means for protecting said coupling.

2. A vehicle according to claim 1, wherein said second portion of the coupling system can be activated so as to pass from a retracted position towards an extended position in which said second portion is adapted to co-operate with said first portion of the coupling system of another vehicle so as to form a coupling between them.

3. A vehicle according to claim 2, wherein said second portion of the coupling system comprises a hitching bar capable of passing automatically from its retracted position to its extended position, and vice versa.

4. A vehicle according to claim 2, wherein said coupling system further comprises means for guiding the displacement of the second portion of the coupling system between the retracted position and the extended position.

5. A vehicle according to claim 2, wherein said coupling system further comprises means for guiding said second portion into co-operation with said first portion of the coupling system.

6. A vehicle according to claim 1, includes further comprising a contactless guidance system.

7. A vehicle according to claim 6, wherein said contactless guidance system uses a reference trace on the ground and obstacle detectors.

8. A vehicle according to claim 1, wherein the coupling system comprises connection means allowing clearance with at least three degrees of freedom.

9. A vehicle according to claim 1, wherein said means for protecting said coupling are configurable from a folded position to a deployed position in which said coupling is surrounded by said means for protecting.

10. A vehicle according to claim 9, wherein said means for protecting comprise a bellows situated at the rear of the vehicle configurable to surround said coupling when in the deployed position.

11. A vehicle according to claim 10 wherein said second portion of the coupling system comprises a hitching bar capable of passing automatically from its retracted position to its extended position, and vice versa, and wherein the free end of said bellows is connected to said hitching bar to follow the movement of the hitching bar.

12. A vehicle according to claim 1, further presents further comprising a system for recovering steering data of the leading vehicle via the coupling so as to enable the following vehicle to follow in the track of the leading vehicle.

13. A vehicle according to claim 1, further comprising a system for replicating controls and information from the driver's cabin between the leading vehicle and the following vehicle, via the coupling.

14. A vehicle according to claim 1, further comprising means for covering the retracted coupling system.

15. A vehicle according to claim 1, wherein the driver's cabin transforms into a passenger space, that prevents access to controls in the driver's cabin.

16. A vehicle according to claim 1, further comprising a software architecture that includes a coupling computer and an axle computer.

17. A vehicle according to claim 16, further comprising means for enabling the coupling computer to determine the situation of the coupling system of said vehicle, including a coupling being formed with another vehicle.

18. A vehicle according to claim 17, the software architecture further comprising a supervisor that makes it possible via the coupling computer to verify the locked position of the coupling between the two vehicles and to issue a warning if said locked position is not engaged.

19. A vehicle according to claim 1, further comprising a steering rear axle.

20. A method for coupling at least two vehicles, the method comprising:
a) moving a first vehicle forming a leading vehicle into a docking location;
b) moving another vehicle forming a following vehicle so as to bring it into alignment behind the leading vehicle at a predetermined docking distance;
c) activating a second portion of a coupling system of the leading vehicle and a first portion of coupling system of the following vehicle so as to form a coupling between them; and
d) activating means for protecting said coupling system, situated at the rear of the leading vehicle to prevent any contact between the coupling and an element outside the vehicle train thus formed.

21. A method according to claim 20, further comprising:
e) moving an additional following vehicle so as to put it in alignment behind the previously coupled following vehicle at a predetermined docking distance;
f) activating a second portion of a coupling system of the additional following vehicle and a first portion of the coupling system of the previously coupled following vehicle that precedes it so as to form an additional coupling between them; and
g) activating the means for protecting said additional coupling, situated at the rear of the previously coupled following vehicle so as to prevent any contact between the additional coupling and an element external to the vehicle train thus formed.

22. A coupling method according to claim 20, wherein moving the following vehicle in step b) comprises moving the following vehicle, using a contactless guidance system.

23. A coupling method according to claim 22, wherein said contactless guidance system uses a reference trace on the road and of obstacle detectors.

24. A method of managing a network for transporting passengers, objects, or both passengers and objects using vehicles, the method comprising:
driving at least two vehicles or vehicle sets from different origins towards one or more bifurcation poles of the network at the boundary between a high-traffic central zone and a lower-traffic peripheral zone; and
performing at said bifurcation pole a coupling method between said vehicles to form a vehicle train having a single driver for movement from the peripheral zone towards the central zone.

25. A vehicle train using vehicles according to claim 1, comprising a single leading vehicle and at least one following vehicle, situated behind the leading vehicle, said vehicles being connected to one another by said coupling, with contact between the coupling and an element external to the vehicles being prevented by said means for protecting.

26. A method for uncoupling the last coupling of a vehicle train, having at least one last following vehicle and a leading vehicle, the method comprising:
activating a means for protecting a last coupling situated between the last following vehicle and the vehicle preceding it so as to disengage said last coupling;
b) activating a second portion of the coupling system of the last following vehicle and the first portion of the coupling system of the vehicle that precedes it so as to undo the last coupling and retract said second portion of the coupling system, whereby the last following vehicle is separated from the vehicle train and forms an autonomous vehicle together with a train of remaining vehicles; and
c) moving said autonomous vehicle or the remaining vehicle train.

27. An uncoupling method according to claim 26, further comprising, after step b), an additional step of activating said means for protecting of the last vehicle of the train of remaining vehicles to hide the retracted second portion of the coupling system.

28. A method of managing a network for transporting people, objects, or both people and objects using vehicles the method comprising:
driving a vehicle train comprising at least two coupled-together vehicles towards a bifurcation pole of the central zone of a network that comprises a high-traffic central zone and a lower-traffic peripheral zone; and
implementing between said vehicles, at said bifurcation pole, the uncoupling method according to claim 25 for breaking up a single-driver vehicle train coming from the central zone to obtain a plurality of individual autonomous vehicles or autonomous vehicle sets heading towards the peripheral zone on different routes towards other stations.

29. A method of managing a network for transporting people, objects, or both people and objects, using vehicles, the method comprising:
driving at least two vehicles or vehicle sets to a bifurcation pole of the network at the boundary between a high-traffic central zone and a lower-traffic peripheral zone;
at said bifurcation pole coupling said vehicles together to form a vehicle train with a single driver when said vehicles are going from the peripheral zone towards the central zone; or
at said bifurcation pole uncoupling said vehicles to break up a single-driver vehicle train coming from the central zone to obtain a plurality of autonomous individual vehicles or autonomous vehicle sets heading towards the peripheral zone along different routes.

30-33. (canceled)
